(19) United States
(12) Patent Application Publication
(10) Pub. No.: US 2021/0390109 A1
(43) Pub. Date: Dec. 16, 2021

(54) EXTRACTING AND POSTING DATA FROM AN UNSTRUCTURED DATA FILE

(71) Applicant: SAP SE, Walldorf (DE)

(72) Inventors: Abaya UNNI, Bangalore (IN); Sivakanth Jayaram, Kerala (IN); Nadhiya Parambath Majeed, Ernakulam (IN)

(21) Appl. No.: 16/901,290

(22) Filed: Jun. 15, 2020

(51) Int. Cl. G06F 16/25; G06F 16/11

(52) U.S. Cl. CPC G06F 16/254; G06F 16/116

(57) ABSTRACT

Disclosed herein are system, method, and computer program product embodiments for extracting and posting data from an unstructured data file to a database table. In an embodiment, a server receives a request to extract and post data from an unstructured data. The server extracts the data from the unstructured data file. The server identifies a set of columns from the structured format of the extracted data. Each column of the set of columns corresponds with a set of data elements from the extracted data. The server identifies a pattern of a set of possible patterns corresponding with each column of the set of columns. Furthermore, the server maps each column of the set of columns with a database column. The server stores each set of data elements of each respective column in the respective database column.

### BACKGROUND

Entities, such as corporations or government institutions, often maintain records in unstructured data files. The unstructured data files can be in the form of PDFs, text documents, e-mails, etc. Manually posting data from the unstructured data file to an Enterprise Resource Planning (ERP) system can be a tedious process. Furthermore, manually posting of data from an unstructured data file can be an error-prone and time-consuming process.

### BRIEF DESCRIPTION OF THE DRAWINGS

The accompanying drawings are incorporated herein and form a part of the specification.

FIG. 1 is a block diagram of a system for extracting and posting data from an unstructured data file, according to some embodiments.

FIG. 2 is a block diagram of a portion of extracted data from an unstructured data file, according to some embodiments.

FIG. 3 is a block diagram of a portion of the extracted data converted into a structured form, according to example embodiments.

FIG. 4 is a flowchart illustrating a process for identifying and posting data from an unstructured data file, according to some embodiments.

FIG. 5 is a flowchart illustrating a converting data extracted from an unstructured data file into a structured format, according to some embodiments.

FIG. 6 is a flowchart illustrating a process for determining a number of columns in the structured format of extracted data, according to some embodiments.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for identifying and loading a relevant page of a dictionary into temporary memory.

In an embodiment, a server receives a request to extract and post data from an unstructured data. The server extracts the data from the unstructured data file and converts the extracted data into a structured format. The server identifies a set of columns from the structured format. Each column of the set of columns corresponds with a set of data elements from the extracted data. The server identifies a pattern of a set of possible patterns corresponding with each column of the set of columns. Furthermore, the server confirms that each corresponding set of data elements matches the pattern corresponding to each respective column and maps each column of the set of columns with a database column. The server stores each set of data elements of each respective column in the respective database column.

This configuration allows for identifying different types of data in an unstructured data file. Furthermore, this configuration allows for mapping the data in an unstructured data file to database columns based on the identified type of data so that the data can be stored in the database column. This reduces possible errors in manually inputting the data in a database. Furthermore, this reduces the possibility of processing erroneous data.

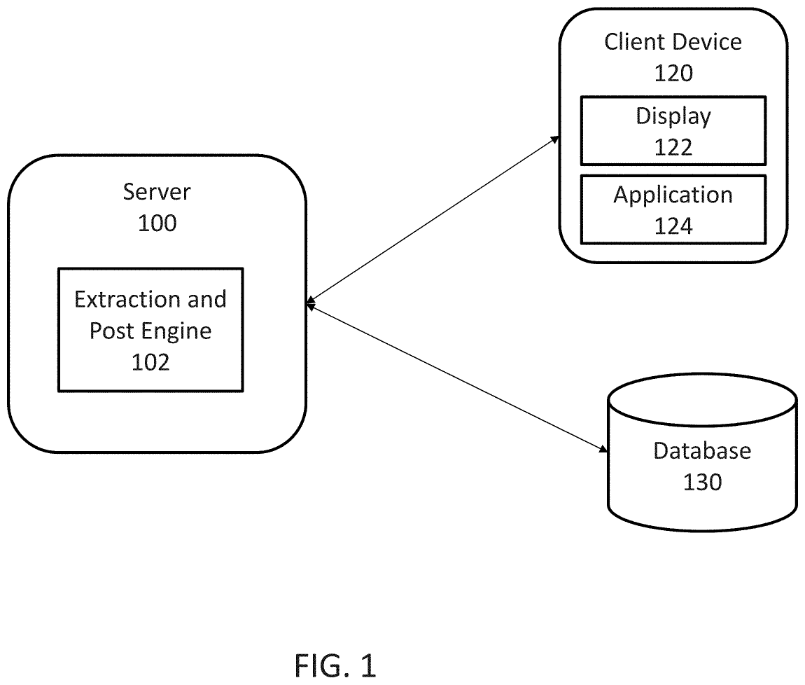

FIG. 1 is a block diagram of a system for extracting and posting data from an unstructured data file, according to some embodiments. In an embodiment, the architecture can include a server 100, client device 120, and database 130. Server 100 can be in communication with client device 120 and database 130. Server 100, client device 120, and database 130 can be connected through wired connections, wireless connections, or a combination of wired and wireless connections.

As an example, server 100, client device 120, and database 130 can be connected through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

Server 100 can include an extraction and post engine 102. Client device 120 can include a display 122 and application 124. Application 124 can be used to interface with server 100 and extraction and post engine 102. Database 130 can include one or more data storage devices configured to store various types of data.

In an embodiment, server 100 can receive a request to extract and post data from an unstructured data file to database 130. The request can include the unstructured data file. The unstructured data file can be a text file, PDF, word document, or the like. The data inside the data file can be formatted in a table layout, including rows and columns. Extraction and post engine 102 can extract the data from the unstructured data file. As an example, the unstructured data file can be a text file. Extraction and post engine 102 can extract the data from the text file as a string. Extraction and post engine 102 can identify the encoding of an unstructured data file and convert the string into a readable format (e.g., a structured format) based on the identified encoding. Encodings can be used to store data from the unstructured data file in computer memory. In particular, encodings can provide a mapping between the data in the unstructured data file and the same data stored in memory. For example, an encoding can represent a given character in the unstructured data file. That is, an encoding stores the particular character. As an example, extraction and post engine 102 can use chardet to identify the encoding of the unstructured data file. Chardet is a python library configured to detect the encoding of files. Chardet can automatically use a sequence of bytes representing data from the unstructured data file to identify the encoding of the unstructured data file.

Extraction and post engine 102 can identify escape characters in the extracted data based on the identified encoding of the unstructured data file. Escape characters are characters that invokes an alternative interpretation on subsequent characters in a character sequence. For example, extraction and post engine 102 can determine the escape character “\n” can represent a new line, and “\t” can represent a tab, based on the identified encoding. Examples of other escape characters can include “\” representing a single quote, “\” representing a double quote, “\\” representing a backslash, “\r” representing a carriage return, “\b” representing a backspace, or representing a “\f” form feed. In this regard, extraction and post engine 102 can split the string (or extracted data) into lines or rows based on the “\n” escape character. By splitting the string (or extracted data) into lines or rows, extraction and post engine 102 can convert the extracted data into a structured format (e.g., a table including columns and rows).

Extraction and post engine 102 can identify a set of columns from the structured format of the data and the number of columns in the set of columns in the structured format of the data. The columns may be separated by a delimiter such as a pipe (|), an asterisk (*), tab, hyphen (-), or the like. Extraction and post engine 102 can differentiate each column based on the delimiter. Extraction and post engine 102 can determine the amount of columns by traversing each line of the structured format of the data and identify a number of words or columns per line based on identifying each column or word separated by a delimiter. Extraction and post engine 102 can generate a list of integers indicating a number of words or columns per line. Extraction and post engine 102 can execute a statistical mod on the list of integers to identify the most frequently occurring integer in the list of integers. The most frequently occurring integer may correspond with the number of columns.

Each column can correspond with a set of data elements. The data elements can be in lines beneath each respective column. Extraction and post engine 102 can generate a 2D array using the set of columns to match a pattern of a set of predefined patterns with the data elements of a given column. Patterns can identify a type of data corresponding to the column. For example, if a type of data is “date,” the pattern can be six digits. If the type of data is currency, the pattern can include a decimal point or a comma.

A first dimension of the 2D array can represent a pattern of a type of data, and the second dimension of the 2D array can represent a column from the set of columns. Extraction and post engine 102 can track the occurrences of a pattern of the type of data matching the pattern of a data element under a respective column. Extraction and post engine 102 can determine which type of pattern corresponds with which column of the set of columns based on the 2D array.

For example, a 2D array is illustrated as follows:

| | Column 0 | Column 1 | Column 2 | Column 3 |
|---|---|---|---|---|
| Pattern: Date (0) | 0 | 0 | 11 | 0 |
| Pattern: | 11 | 0 | 0 | 0 |
| Numeric (serial | | | | |
| numbers) (1) | | | | |
| Pattern: Currency | 0 | 0 | 0 | 11 |
| (2) | | | | |
| Pattern: Alpha | 0 | 11 | 0 | 0 |
| Numeric (3) | | | | |

As shown in the 2D array, the extraction and post engine 102 identified 11 occurrences of a pattern corresponding to a date value in the data elements in column 2, 11 occurrences of a pattern corresponding to an alpha numeric (e.g., name) value in data elements in column 1, 11 occurrences of a pattern corresponding to a currency value in data elements in column 3, and 11 occurrences of a pattern corresponding to an numeric (serial numbers) value in column 0. In this regard, column 0 corresponds with numeric (serial numbers) values, column 1 corresponds to alpha numeric (e.g., name) values, column 2 corresponds with date values, and column 3 corresponds with currency values.

Extraction and post engine 102 can confirm that each data element in a column matches the pattern corresponding to the column. Each data element that does not match the type of pattern is discarded or ignored. For example, based on the above example, a data element that includes eight digits, disposed in column 2, will be disregarded because it does not match a pattern corresponding to a date value. Extraction and post engine 102 maps each column of the set of columns to a column of a database table stored in the database 130 based on the type of pattern corresponding to the set of columns. For example, based on the above example, data elements in column 0 are mapped to a column in the database 130 storing numeric values, data elements in column 1 are mapped to a column in the database 130 storing alpha numeric, data elements in column 2 are mapped to a column in the database 130 storing date values, and data elements in column 3 are mapped to a column in the database 130 storing currency. Extraction and post engine 102 can post the data elements corresponding to each respective column to the corresponding column in database 130. The database table can be identified based on the extracted data. Alternatively, the database table can be identified based on the request.

In an embodiment, extraction and post engine 102 can identify a language of the unstructured data file based on using the extracted data. As an example, extraction and post engine 102 can use TextBlob to identify the language of the unstructured data file. TextBlob is a Python library for processing textual data. It provides an API for natural language processing (NLP) tasks such as part-of-speech tagging, noun phrase extraction, sentiment analysis, classification, translation, and more. Based on the identified language, extraction, and post engine 102 can identify column headers of the structured format of the extracted data. For example, in the event, the language of the unstructured data file is Spanish. Extraction and post engine 102 can determine that the language is Spanish by using TextBlob. Furthermore, extraction and post engine 102 can determine the unstructured data file includes a column corresponding to a date by recognizing the word “fecha” (which translates to “date” in English).

In an embodiment, extraction and post engine 102 can identify the type of currency values in the unstructured data file. For example, extraction and post engine 102 can use Forex-Python to identify the currency of currency values in the unstructured data file. This can assist extraction and post engine 102 to match a pattern of the identified currency with the pattern of the data elements. For example, a currency of a foreign country can have a different pattern than U.S. currency. In this regard, if extraction and post engine 102 attempts to match data elements to a pattern corresponding to U.S. currency, extraction and post engine 102 may ignore relevant currency values. Therefore, by identifying that a given column corresponds with a foreign currency, extraction and post engine 102 can attempt to match the pattern corresponding to the foreign currency to the data elements of the given column.

As a non-limiting example, the system for extracting and posting data from an unstructured data file can be used to post payment data from invoices. For example, a Remittance advice/Payment Advice is a document, which provides a breakdown of the invoices included on a payment. A customer sends the Remittance advice/Payment Advice to a supplier letting the supplier know they have paid their invoice. In its simplest form, it shows the invoice number and payment amount sent or enclosed. Whenever a customer pays a supplier, the customer may also send a remittance advice, which shows each invoice and credit note that have paid, and the total amount of the payment. This allows the supplier to correctly allocate the payment against invoices, saving both the supplier and the customer time if they had to correspond with each other to reconcile payments. The finance department of both the parties must keep track of all the payment advices received/sent. The Remittance advice/Payment Advice can be an unstructured data file. It can include a date, reference number, and amount paid for each invoice.

The server 100 can receive the Remittance advice/Payment Advice from the client application 124. The extraction and post engine 102 can identify the data from the Remittance advice/Payment Advice as described above. The extraction and post engine 102 can post the payment advices to the respective column in the database 130, as described above. This allows the system to efficiently and quickly extract and post payment data from numerous Remittance advice/Payment Advice files to database 130.

In some embodiments, the request to extract and post data from an unstructured data file to database 130 can include a particular type of data to post to the database 130. For example, the request can include instructions to post currency values included in the unstructured data file. In this regard, extraction and post engine 102 can identify all the data elements that match a pattern corresponding to the currency value and post the data elements corresponding to currency values to the database 130.

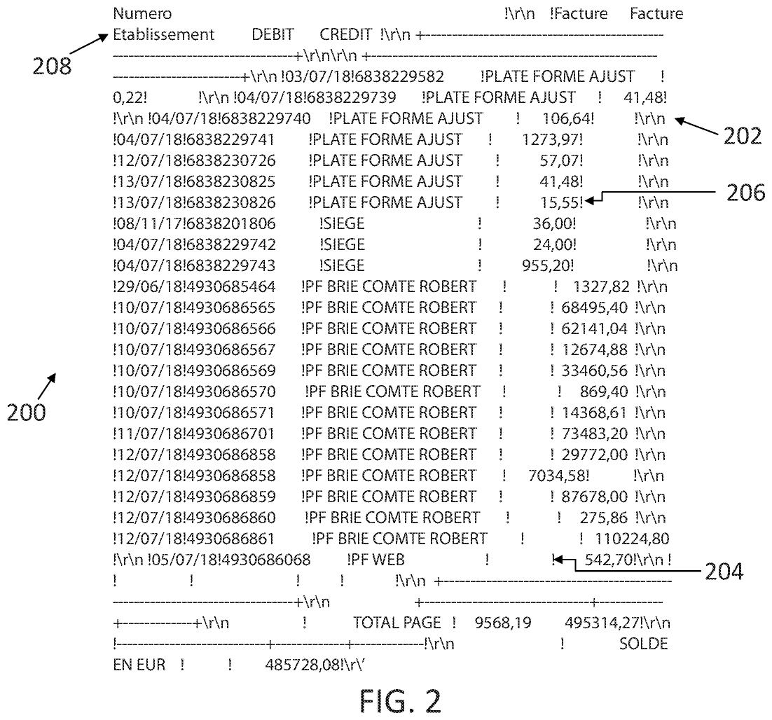

FIG. 2 illustrates extracted data 200 from an unstructured data file according to some embodiments. Extracted data 200 can include escape characters 202, such as “\r” and “\n.” Escape characters 202 “\r” and “\n” may represent a carriage return and a new line. Extracted data 200 can also include extraneous characters 204, such as an “!”. Extracted data 200 can further include data elements 206, such as currency data elements and column headers 208.

In response to receiving a request to identify and post data elements 206, the extraction and post engine (e.g., extraction and post engine 102 as shown in FIG. 1) can identify the encoding of extracted data 200 and convert extracted data 200 into a structured format based on the identified encoding.

For example, escape characters 202 can be identified based on the encoding. Escape characters 202 can be used to convert extracted data 200 into a structured format. For example, escape characters 202 “\n” and “\r” can be used to split extracted data 200 into lines or rows. By doing so, data elements 206 can be aligned with their respective columns.

The extraction and post engine can traverse the structured format of extracted data 200 and count the number of words or columns per line. As an example, the extraction and post engine can count each column header 208. The extraction and post engine can generate a list of integers indicating the number of words or columns per line. The extraction and post engine can take a statistical mod of the list of integers. Based on the statistical mod, the extraction and post engine can determine the most frequently occurring integer in the list of integers. The most frequently occurring integer in the list of integers can be the number of columns. Each column can correspond with data elements 206.

The extraction and post engine can identify a type of data corresponding to a given column by matching a predefined pattern with data elements 206 corresponding to the given column. In some embodiments, data elements 206 can be currency values. The currency values can be written in different patterns depending on the currency. For example, in certain currencies a decimal point to separate dollars and cents and other currencies use commas to separate dollars and cents. In other words, certain currencies can separate the tenths and hundredths from the ones, tens, hundreds, thousands using a decimal point and other currencies can use commas to separate the tenths and hundredths from the ones, tens, hundreds, thousands. In this regard, the extraction and post engine can identify the specific currency of the currency value to match the pattern of the currency value to the appropriate pattern.

The extraction and post engine can confirm each data element for each column matches the pattern corresponding to each respective column. Extraneous characters 204 that are not part of the pattern can be ignored or disregarded when attempting to identify data elements 206. For example, a pattern for a currency value can be numerical values separated by a decimal point. Extraneous characters 204, such as “!” may be ignored or disregarded.

The extraction and post engine can map each column to a column in the database. In response to confirming that each data element matches a pattern corresponding to each respective column, the extraction and post engine can post each data element to a column in the database, which corresponds with the respective column of the respective data element.

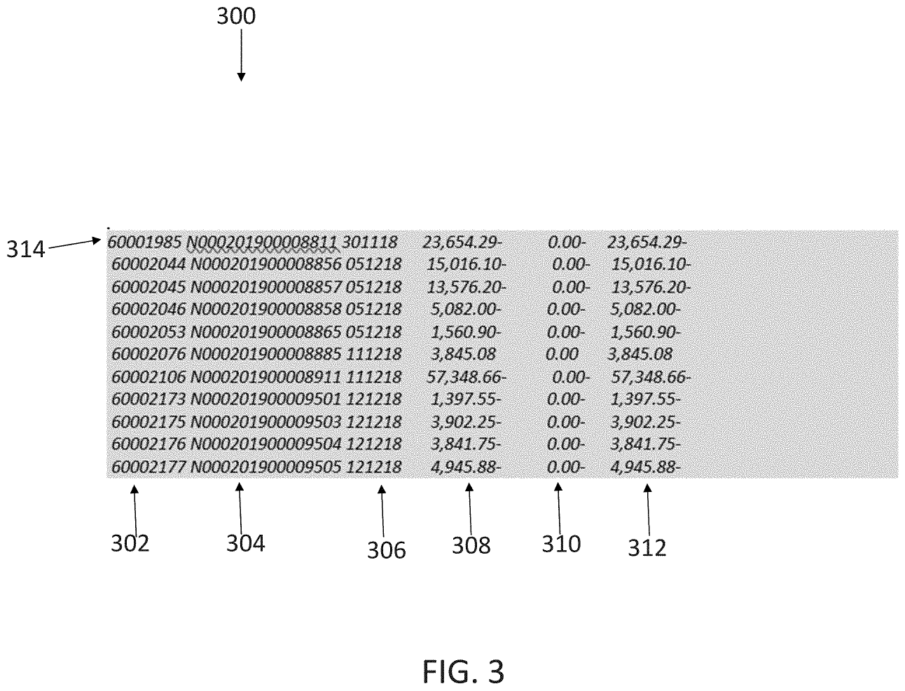

FIG. 3 illustrates a structured format 300 of data extracted from an unstructured data file according to some embodiment. The structured format 300 can be divided into columns and rows. As an example, the structured format can include columns 302-312. Each column can correspond to data elements 314 of different types.

The extraction and post engine (e.g., extraction and post engine 102, as shown in FIG. 1) can match a pattern of the data elements corresponding to a given column to predefined patents. As an example, data elements 314 in column 302 can correspond to an identification number (unique identifier), data elements 314 in column 304 can correspond to a payment identifier, data elements 314 in column 306 can correspond to a date, data elements 314 in columns 308-312 can correspond with various currency values (e.g., debit, credit, amount paid, the amount received, total, or the like). In this regard, the extraction and post engine can determine that data elements 314 in column 306 are six digits. In view of this, the extraction and post engine can attempt to match the pattern of a date value to the data elements 314. Based on this, extraction and post engine can determine that the data elements of 314 of column 302 are date values.

In another example, extraction and post engine can determine that data elements 314 in column 308 include numerical values separated by a comma and decimal points. In light of this, the extraction and post engine can match a pattern for a currency value to the data elements of 314. Based on this, extraction and post engine can determine that the data elements 314 of column 308 are currency values.

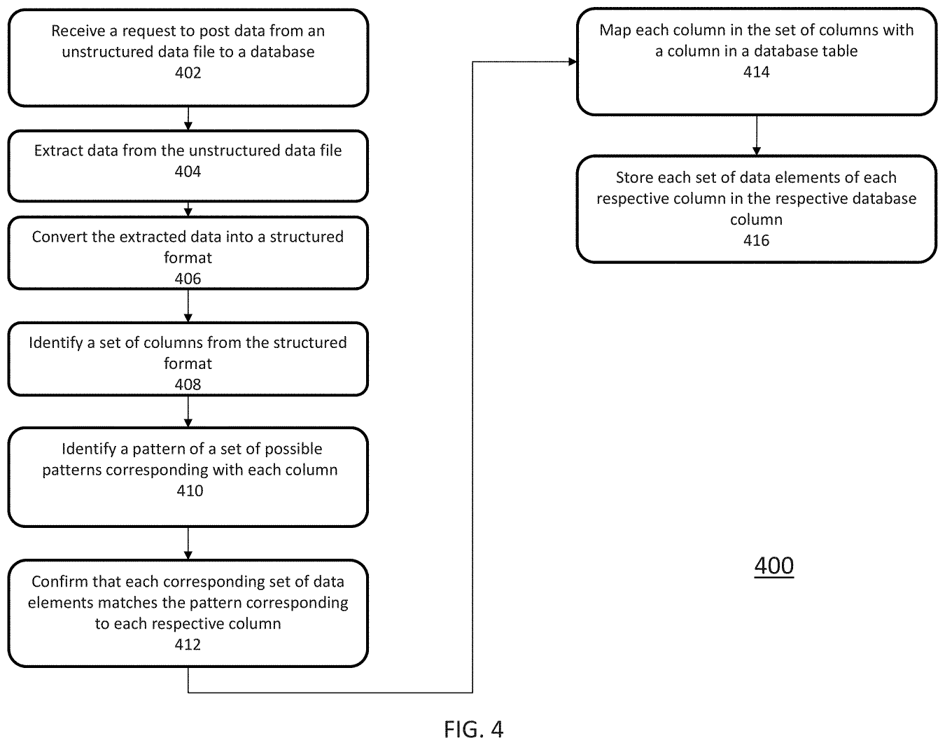

FIG. 4 is a flowchart illustrating a process for identifying and posting data from an unstructured data file, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 4, as will be understood by a person of ordinary skill in the art.

Method 400 shall be described with reference to FIG. 1. However, method 400 is not limited to that example embodiment.

In 402, server 100 receives a request to post data from an unstructured data file to a database. The request can include an unstructured data file. The unstructured data file can be text files, documents, PDFs, or the like ( ). The data inside the unstructured data file can be structured in a table format, including columns and rows.

In 404, extraction and post engine 102 extracts data from the unstructured data file. As an example, if the unstructured data file is a text file, extraction and post engine 102 can extract the data from the text file as a string. The string can include the data in the text file as well as escape characters.

In 406, extraction and post engine 102 converts the extracted data into a structured format. The extraction and post engine 102 can use the escape characters to convert the extracted data into a structured form. The structured format can be a table that includes rows and columns. Each column can be separated by a delimiter.

In 408, extraction and post engine 102 identifies a set of columns from the structured format. Each column of the set of columns corresponds with a set of data elements from the extracted data. The data elements corresponding to the column can be included in lines underneath the column.

In 410, extraction and post engine 102 identifies a pattern of a set of possible patterns corresponding with each column of the set of columns. The extraction and post engine generates a 2D array using the set of columns to identify the pattern corresponding with each column. A first dimension of the 2D array can be a pattern of a given type of data, and the second dimension of the 2D array can be the set of columns. Extraction and post engine 102 can traverse through each data element of a given column and match a pattern of the set of patterns with the data element. For each occurrence of a match, extraction and post engine 102 can map the occurrence with the respective pattern and column in the 2D array. The most occurrences of a given pattern in a column indicate that the given pattern corresponds with the column. Furthermore, the given pattern corresponding with the column indicates that the data elements in the column are a type of data corresponding to the pattern.

In 412, extraction and post engine 102 confirms that each corresponding set of data elements matches the pattern corresponding to each respective column. Extraction and post engine 102 can eliminate, exclude, ignore, or disregard and data elements in a column that do not match the pattern of the type of data corresponding to the column. For example, if the pattern corresponds to a date value, and a data element is eight digits, extraction and post engine 102 can determine that the data element is not a date and should be ignored.

In 414, extraction and post engine 102 maps each column in the set of columns with a column in a database table. The database table can be stored in database 130. As an example, the database table can be identified based on the extracted data from the unstructured data file. Alternatively, the database table can be identified in the request.

In 416, extraction and post engine 102 stores each set of data elements of each respective column in the respective database column. Extraction and post engine 102 can store the set of data elements in the respective database column based on the mapping of the column of the respective data element to the respective database column.

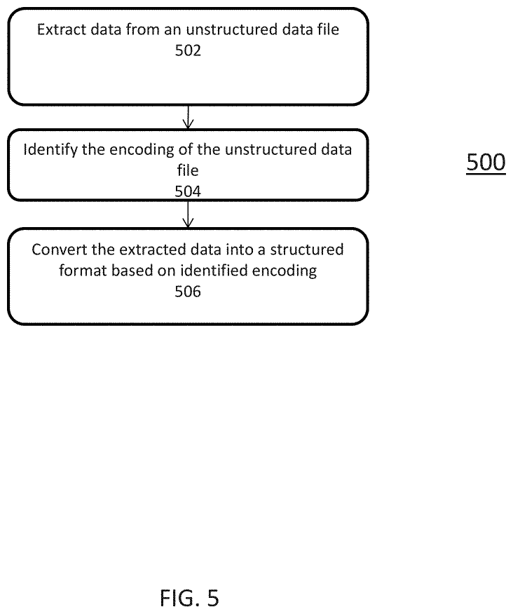

FIG. 5 is a flowchart illustrating a converting data extracted from an unstructured data file into a structured format, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 5, as will be understood by a person of ordinary skill in the art.

Method 500 shall be described with reference to FIG. 1. However, method 500 is not limited to that example embodiment.

In 502, extraction and post engine 102 extracts data from an unstructured data file. The data can include data elements as well as escape characters. Escape characters is a character that invokes an alternative interpretation of subsequent characters in a character sequence.

*In 504, extraction and post engine 102 identifies the encoding of the unstructured data file. The encoding of a file may depend on the type of file. For example, a text file may have a different encoding than a PDF file. The encodings may define how to handle escape characters. For example, the encoding of a text file may indicate that “\n” indicates a “new line.”

In 506, extraction and post engine 102 converts the extracted data into a structured format based on identified encoding. For example, in the event, the unstructured data file is a text file extraction and post engine can extract the data from the unstructured data file as a string. The string can include the data and escape characters such as \n or \r indicating a new line or carriage return. The extraction and post engine can split the string into lines or rows based on the escape characters. The structured format can be a table, including columns and rows.

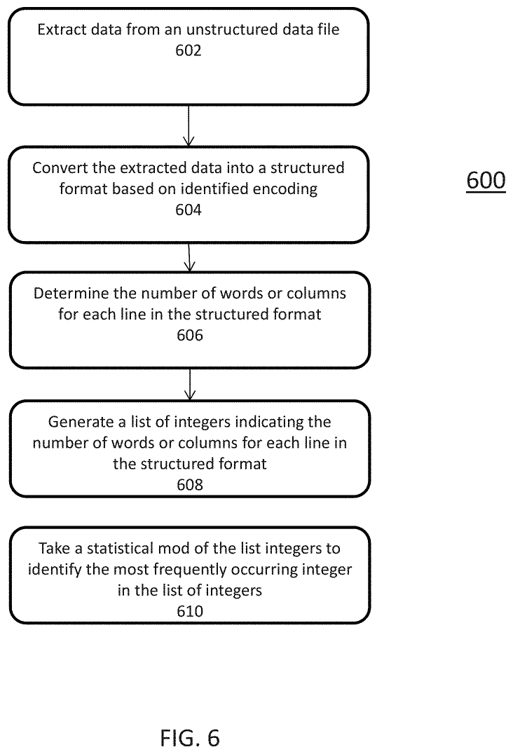

FIG. 6 is a flowchart illustrating a process for determining a number of columns in the structured format of the extracted data, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 6, as will be understood by a person of ordinary skill in the art.

Method 600 shall be described with reference to FIG. 1. However, method 600 is not limited to that example embodiment.

In 602, extraction and post engine 102 extracts data from an unstructured data file. The data can include data elements as well as escape characters. Escape characters is a character that invokes an alternative interpretation on subsequent characters in a character sequence.

In 604, extraction and post engine 102 converts the extracted data into a structured format based on an identified encoding. For example, in the event, the unstructured data file is a text file extraction and post engine can extract the data from the unstructured data file as a string. The string can include the data and escape characters such as \n or \r indicating a new line or carriage return. The extraction and post engine can split the string into lines or rows based on the escape characters. The structured format can be a table including columns and rows. The columns or words can be separated by delimiters.

In 606, extraction and post engine 102 determines the number of words or columns for each line in the structured format. Extraction and post engine 102 can distinguish between different columns based on the delimiters.

In 608, extraction and post engine 102 generates a list of integers indicating the number of words or columns for each line in the structured format. As an example, each integer in the list can represent the number of words or columns for each line in the structured format.

In 610, extraction and post engine 102 takes a statistical mod of the list integers to identify the most frequently occurring integer in the list of integers. A statistical mod operation identifies the congruency of values, such as the list of integers. The most frequently occurring integer corresponds with the number of columns. For example, if the integer 5 occurs the most frequently in the list of integers, extraction and post engine 102 determines there are 5 columns.

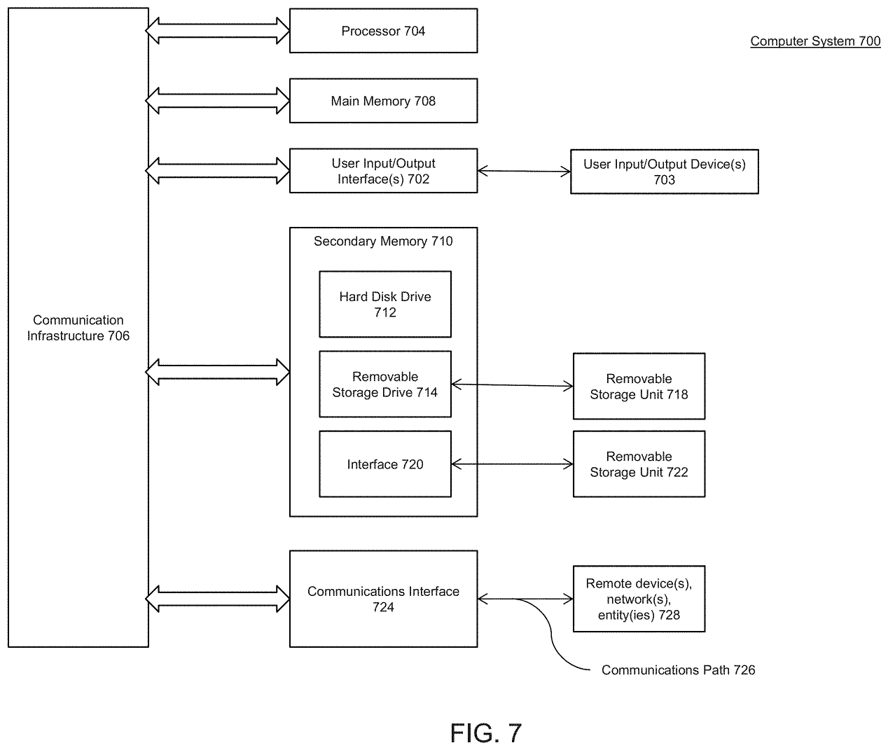

Various embodiments can be implemented, for example, using one or more computer systems, such as computer system 700 shown in FIG. 7. Computer system 700 can be used, for example, to implement method 400 of FIG. 4, 500 of FIG. 5, and 600 of FIG. 6. Furthermore, computer system 700 can be at least part of server 100, as shown in FIG. 1. For example, computer system 700 can extract and post data from an unstructured data file to database 130. Computer system 700 can be any computer capable of performing the functions described herein.

Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 can include one or more levels of cache. Main memory 708 has stored therein control logic (i.e., computer software) and/or data.

Computer system 700 can also include one or more secondary storage devices or memory 710. Secondary memory 710 can include, for example, a hard disk drive 712 and/or a removable storage device or drive 714. Removable storage drive 714 can be a floppy disk drive, a magnetic tape drive, a compact disk drive, an optical storage device, tape backup device, and/or any other storage device/drive.

Removable storage drive 714 can interact with a removable storage unit 718. Removable storage unit 718 includes a computer usable or readable storage device having stored thereon computer software (control logic) and/or data. Removable storage unit 718 can be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 can include other means, instrumentalities, or other approaches for allowing computer programs and/or other instructions and/or data to be accessed by computer system 700. Such means, instrumentalities, or other approaches can include, for example, a removable storage unit 722 and an interface 720. Examples of the removable storage unit 722 and the interface 720 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 can further include a communication or network interface 724. Communication interface 724 enables computer system 700 to communicate and interact with any combination of remote devices, remote networks, remote entities, etc. (individually and collectively referenced by reference number 728). For example, communication interface 724 can allow computer system 700 to communicate with remote devices 728 over communications path 726, which can be wired and/or wireless, and which can include any combination of LANs, WANs, the Internet, etc. Control logic and/or data can be transmitted to and from computer system 700 via communication path 726.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
receiving, by one or more computing devices, a request to extract and post data from an unstructured data file, wherein the request includes the unstructured data file;
converting, by the one or more computing devices, the data extracted from the unstructured data file into a structured format;
identifying, by the one or more computing devices, a set of columns from the structured format, wherein each column of the set of columns corresponds with a set of data elements from the extracted data;
identifying, by the one or more computing devices, a pattern of a set of possible patterns corresponding with each column of the set of columns; and
storing, by the one or more computing devices, each set of data elements of each respective column in a respective database column based on an identified pattern corresponding to the respective column.

2. The method of claim 1, further comprising generating, by the one or more computing devices, a 2D array to identify the pattern of a set of possible patterns corresponding with each column of the set of columns, wherein a first dimension of the 2D array includes the set of columns and a second dimension of the 2D array includes the set of patterns.

3. The method of claim 2, wherein the 2D array includes each occurrence of each respective pattern in each respective set of data elements of each respective column of the set of columns.

4. The method of claim 1, further comprising identifying, by the one or more computing devices, a delimiter in the extracted data to identify each column of the set of columns.

5. The method of claim 1, further comprising:
identifying, by the one or more computing devices, an encoding of the unstructured data file; and
converting, by the one or more computing devices, the extracted data in the structured format based on the encoding of the unstructured data file.

6. The method of claim 1, further comprising eliminating, by the one or more computing devices, a subset of data elements of the set of data elements, which fail to match a given pattern corresponding to a given column.

7. The method of claim 1, further comprising:
traversing, by the one or more computing devices, each line of the unstructured data file;
generating, by the one or more computing devices, a list of integers indicating a number of words or columns per line of the unstructured data file;
executing, by the one or more computing devices, a statistical mod to identify a most frequently occurring integer in the list of integers to identify a number of columns of the set of columns.

8. The method of claim 1, further comprising:
identifying, by the one or more computing devices, a type of data of a given data element, in response to confirming that the given data element matches the pattern corresponding to a given column of the given data element.

9. The method of claim 1, further comprising:
identifying, by the one or more computing devices, a language of the data from the unstructured data file.

10. A system comprising:
a memory; and
at least one processor coupled to the memory and configured to:
receive a request to extract and post data from an unstructured data file, wherein the request includes the unstructured data file;
convert the data extracted from the unstructured data file into a structured format;
identify a set of columns from the structured format, wherein each column of the set of columns corresponds with a set of data elements from the extracted data;
identify a pattern of a set of possible patterns corresponding with each column of the set of columns; and
store each set of data elements of each respective column in a respective database column based on an identified pattern corresponding to the respective column.

11. The system of claim 10, wherein the at least one processor is further configured to generate a 2D array using the set of columns to identify the pattern of a set of possible patterns corresponding with each column of the set of columns, wherein a first dimension of the 2D array includes the set of columns and a second dimension of the 2D array includes the set of patterns.

12. The system of claim 11, wherein the 2D array includes each occurrence of each respective pattern in each respective set of data elements of each respective column of the set of columns.

13. The system of claim 10, wherein the at least one processor is further configured to identify a delimiter in the extracted data to identify each column of the set of columns.

14. The system of claim 10, wherein the at least one processor is further configured to:
identify an encoding of the unstructured data file; and
convert the extracted data in the structured format based on the encoding of the unstructured data file.

15. The system of claim 10, wherein the at least one processor is further configured to eliminate a subset of data elements of the set of data elements, which fail to match a given pattern corresponding to a given column.

16. The system of claim 10, wherein the at least one processor is further configured to:
traverse each line of the unstructured data file;
generate a list of integers indicating a number of words or columns per line of the unstructured data file;
execute a statistical mod to identify a most frequently occurring integer in the list of integers to identify a number of columns of the set of columns.

17. The system of claim 10, wherein the at least one processor is further configured to:
identify a type of data of a given data element in response to confirming that the data element matches a given pattern corresponding to a given column of the data element.

18. The system of claim 10, wherein the at least one processor is further configured to
identify a language of the data in the unstructured data file.

19. A non-transitory computer-readable device having instructions stored thereon that, when executed by at least one computing device, cause the at least one computing device to perform operations comprising:
receiving a request to extract and post data from an unstructured data file, wherein the request includes the unstructured data file;
converting the data extracted from the unstructured data file into a structured format;
identifying a set of columns from the structured format of the extracted data, wherein each column of the set of columns corresponds with a set of data elements from the extracted data;
identifying a pattern of a set of possible patterns corresponding with each column of the set of columns; and
storing each set of data elements of each respective column in a respective database column based on an identified pattern corresponding to the respective column.

20. The non-transitory computer-readable device of claim 19, wherein the operations further comprises:
identifying an encoding of the unstructured data file; and
converting the extracted data structured format based on the encoding of the unstructured data file.
